(19) United States
(12) Patent Application Publication
(10) Pub. No.: US 2021/0390564 A1
(43) Pub. Date: Dec. 16, 2021

(54) AUTOMATED THIRD-PARTY DATA EVALUATION FOR MODELING SYSTEM

(71) Applicant: Hartford Fire Insurance Company, Hartford, CT (US)

(72) Inventors: Kudakwashe F. Chibanda, Brooklyn, NY (US); Sterling M. Cutler, West Hartford, CT (US); Daniela Fassbender, Holland, MI (US); Haibin Li, Livingston, NJ (US); Jing-Ru Jimmy Li, Hartford, CT (US); Cyan Justina Manuel, Chattanooga, TN (US); Ahmad J. Paintdakhi, New Milford, CT (US); Alexi Resto, Bloomfield, CT (US); Peter Ross Thomas-Melly, Northampton, MA (US)

(21) Appl. No.: 16/902,901

(22) Filed: Jun. 16, 2020

(51) Int. Cl. G06Q 30/02; G06N 20/00; G06Q 10/06; G06Q 40/08

(52) U.S. Cl. CPC G06Q 30/0201; G06Q 40/08; G06Q 10/0635; G06N 20/00

(57) ABSTRACT

In some embodiments, a system may evaluate third-party data for an enterprise (e.g., a potential risk enterprise such as an insurance company), based on information about potential customers received via a first-party data source and additional information about the potential customers from sources other than the enterprise received via a third-party data source. A model factory may provide information about at least one enterprise predictive model, and a third-party data evaluation platform may analyze the additional information to determine an impact on the enterprise predictive model. The third-party data evaluation platform may then output an indication of a result of said analysis to a database of findings (e.g., for use by data scientists).

### BACKGROUND

An entity, such as an enterprise that analyzes risk information, may want to analyze or “mine” large amounts of data, such as internal enterprise data and/or data that is available from other parties (e.g., “third-party data”). For example, a risk enterprise might want to analyze tens of thousands of credit files to look for detailed information about potential customers (e.g., customer names, addresses, ZIP codes, etc.). Note that an entity might analyze this data in connection with different types of risk-related models, and, moreover, different models may use the data differently. For example, a description of a business or residence might have different meanings depending on the types of risk being evaluated. It can be difficult, however, to identify useful information across such large amounts of data and different types of predictive models. In addition, manually managing the different needs and requirements (e.g., different business logic rules) associated with various models can be a time consuming and error prone process. Increasingly, third-party data has a shorter and shorter shelf life (and the amount of data available is growing at a substantial rate). As a result, data scientists spend a substantial amount of valuable time trying to figure out if new third-party data has any real value to the enterprise. It would therefore be desirable to provide improved third-party data evaluation for a modeling system.

### SUMMARY OF THE INVENTION

According to some embodiments, systems, methods, apparatus, computer program code and means are provided to improve third-party data evaluation for a modeling system. In some embodiments, a system may evaluate third-party data for an enterprise (e.g., a potential risk enterprise such as an insurance company) based on information about potential customers received via a first-party data source and additional information about the potential customers from sources other than the enterprise received via a third-party data source. A model factory may provide information about at least one enterprise predictive model, and a third-party data evaluation platform may analyze the additional information to determine an impact on the enterprise predictive model. The third-party data evaluation platform may then output an indication of a result of said analysis to a database of findings (e.g., for use by data scientists).

Some embodiments provide: means for receiving from an enterprise information about potential customers via a first-party data source; means for receiving from sources other than the enterprise additional information about the potential customers via a third-party data source; means for receiving information about at least one enterprise predictive model from a model factory; means for analyzing, by a third-party data evaluation platform, the additional information to determine an impact on the enterprise predictive model; and means for storing an indication of a result of said analysis in a database of findings.

A technical effect of some embodiments of the invention is improved third-party data evaluation for a modeling system. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method in accordance with some embodiments of the present invention.

FIG. 3 is a modeling workflow according to some embodiments.

FIG. 4 is a modeling process ecosystem in accordance with some embodiments.

FIG. 5 is a modeling system schema according to some embodiments.

FIG. 6 illustrates data science assets in accordance with some embodiments.

FIG. 7 is a modeling system data strategy according to some embodiments.

FIG. 8 is a data science modeling system workflow in accordance with some embodiments.

FIG. 9 is a generic model factory according to some embodiments.

FIG. 10 is a general third-party data evaluation setup in accordance with some embodiments.

FIG. 11 illustrates third-party data evaluation orchestration according to some embodiments.

FIG. 12 illustrates third-party data scorecards in accordance with some embodiments.

FIG. 13 is a machine learning refinery display in accordance with some embodiments.

FIG. 14 is block diagram of a platform according to some embodiments of the present invention.

FIG. 15 illustrates a tabular portion of a machine learning refinery database in accordance with some embodiments.

FIG. 16 illustrates a wireless or handheld tablet device in accordance with some embodiments of the present invention.

### DETAILED DESCRIPTION

The present invention provides significant technical improvements to facilitate a monitoring and/or processing of third-party data, risk related data modeling, and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the areas of data and model monitoring and/or processing by providing benefits in data accuracy, analysis speed, data availability, and data integrity, and such advances are not merely a longstanding commercial practice. The present invention provides improvement beyond a mere generic computer implementation as it involves the processing and conversion of significant amounts of data in a new beneficial manner as well as the interaction of a variety of specialized risk-related applications and/or third-party systems, networks, and subsystems. For example, in the present invention third-party data and related risk information may be processed, forecast, and/or scored via an analytics engine and results may then be analyzed efficiently to evaluate risk-related data, thus improving the overall performance of an enterprise system, including message storage requirements and/or bandwidth considerations (e.g., by reducing a number of messages that need to be transmitted via a network). Moreover, embodiments associated with predictive models might further improve the performance of claims processing applications, resource allocation decisions, reduce errors in templates, improve future risk estimates, etc.

An enterprise may want to analyze or “mine” large amounts of data, such as third-party data received from various sources. By way of example, a risk enterprise might want to analyze tens of thousands of risk-related third-party data files to look for useful information (e.g., to find information that might correct and/or supplement existing first-party data used by the enterprise). Note that an entity might analyze this data in connection with different types of applications (e.g., potential risk applications of an insurance company), and that different applications may need to analyze the data differently. It may therefore be desirable to provide systems and methods that permit third-party data evaluation for a modeling system in an automated, efficient, and accurate manner.

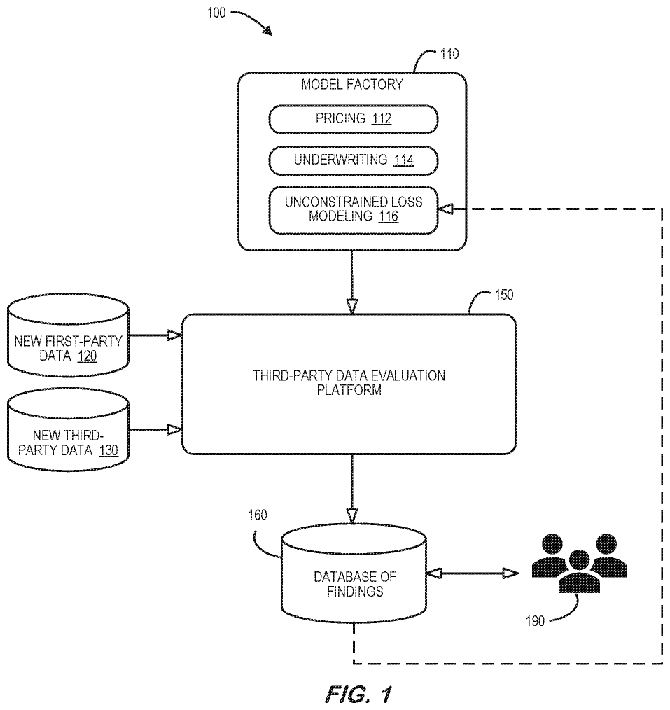

FIG. 1 is block diagram of a system 100 according to some embodiments of the present invention. The system includes a model factory 110 that might have a pricing module 112, an underwriting module 114, an unconstrained loss monitoring module 116, etc. The model factory 110 provides information to a third-party data evaluation platform 150 that also receives new first-party data 120 and new third-party data 130 (e.g., information about an entity at a ZIP code or state level). Examples of new third-party data 130 might include, for example, information from EXPERIAN®, Dun & Bradstreet (“D&B”), the Bureau of Labor Statistics (“BLS”), the National Oceanic and Atmospheric Administration (“NOAA”), TransUnion credit scores, credit reports and credit checks, etc.

The pricing module 112 may feed an initial baseline model to the third-party data evaluation platform 150. The third-party data evaluation platform 150 may then bring in the new first-party and third-party data 120, 130 elements and kick off a data analysis processing loop and/or a scorecard processing loop. The results may then be stored in a database of findings 160 for use by data scientists and/or an unconstrained loss modeling team 190 (to determine important information and feedback that data to the unconstrained loss modeling component 116). This process might be performed automatically or be initiated via a command from a remote interface device. As used herein, the term “automatically” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The third-party data evaluation platform 150 may store information into and/or retrieve information from various data stores (e.g., the database of findings 160), which may be locally stored or reside remote from the third-party data evaluation platform 150. Although a single third-party data evaluation platform 150 and model factory 110 are shown in FIG. 1, any number of such devices may be included. Moreover, various devices described herein might be combined according to embodiments of the present invention. For example, in some embodiments, the third-party data evaluation platform 150 and database of findings 160 might comprise a single apparatus. Any of the system 100 functions may be performed by a constellation of networked apparatuses, such as in a distributed processing or cloud-based architecture.

A user or administrator may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to define advanced rules or business logic) and/or provide or receive automatically generated recommendations or results from the system 100.

Ingestion of information into the third-party data evaluation platform 150 may include key assignment and ingestion of existing tags (e.g., latitude and longitude) that are associated with the data. This information might then be processed to determine an appropriate domain assignment (e.g., using general tag learning and artificial intelligence) and/or custom tagging (e.g., using custom tags and feedback from users) to create a broad set of tags. As a result, the system 100 might automatically evaluate data quality (e.g., duplication), size, timeliness, grain, completeness, etc. Moreover, embodiments may leverage matching for name and/or address matching, perform dislocation analysis (how does the new third-party data 130 “move” groupings), asses which variables have the strongest relationship with a target using a Least Absolute Shrinkage and Selection Operator (“LASSO”) algorithm, a Gradient Boosting Machine (“GBM”) algorithm, a Random Forest (“RF”) method, etc. The system 100 may use an existing model as a baseline to determine how much additional impact the third-party data 130 has on the model (e.g., by comparing the performance of existing variables and new variables on a predictive enterprise model).

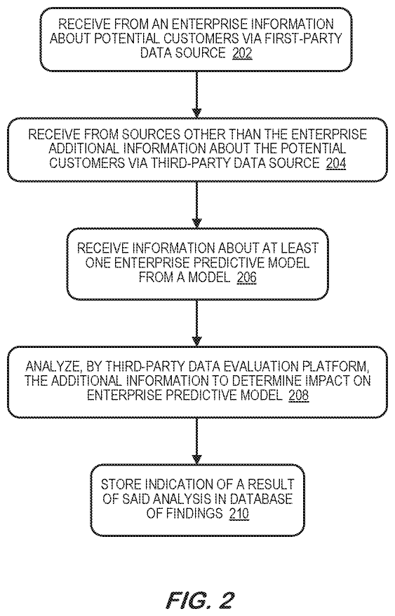

In this way, the system 100 may mine third-party data in an efficient and accurate manner. For example, FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, the system may receive from an enterprise information about potential customers via a first-party data source. At 204, the system may receive from sources other than the enterprise additional information about the potential customers via a third-party data source. The information from the first-party or third-party data source might be associated with, for example, a risk claim file, a risk claim note, a medical report, a police report, social network data, web image data, Internet of Things data, Global Positioning System (“GPS”) satellite data, activity tracking data, big data information, a loss, an injury, a first notice of loss statement, video chat stream, optical character recognition data, a governmental agency, etc.

At 206, the system may receive information about at least one enterprise predictive model from a model factory. In some embodiments, a plurality of enterprise predictive models are associated with a plurality of risk applications, including at least two of: a workers' compensation claim, a personal risk policy, a business risk policy, an automobile risk policy, a home risk policy, a sentiment analysis, risk event detection, a cluster analysis, a predictive model, a subrogation analysis, fraud detection, a recovery factor analysis, large loss and volatile claim detection, a premium evasion analysis, a risk policy comparison, an underwriting decision, indicator incidence rate trending, etc.

At 208, the system may analyze, by a third-party data evaluation platform, the additional information to determine an impact on the enterprise predictive model. At 210, the system may store an indication of a result of said analysis in a database of findings. According to some embodiments, the indication of the result of said analysis will trigger a risk application and/or update a risk application. Moreover, in some embodiments, the indication of the result of said analysis is associated with a variable or weighing factor of a predictive model.

According to some embodiments, the system may also execute performance monitoring to automatically and proactively identify potential issues. This identification might be performed, for example, via cloud analytics associated with object storage, a data catalog, a data lake store, a data factory, machine learning, artificial intelligence services, etc. Moreover, in some embodiments the system automatically re-trains the enterprise predictive model using the additional information about the potential customers from the third-party data source and automatically scores the additional information about the potential customers from the third-party data source.

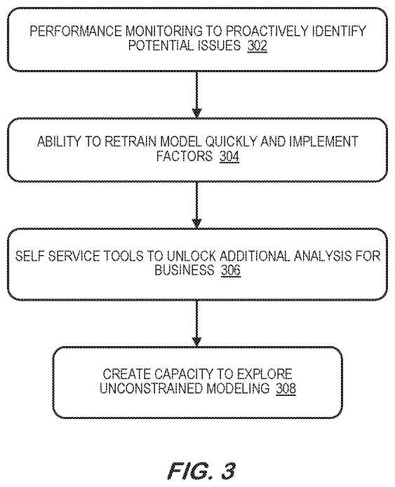

FIG. 3 is a modeling workflow according to some embodiments. Note that typical model rebuilds require extensive resources and time commitment. Moreover, it involves cumbersome processes and competing priorities that may hinder unconstrained modeling practices. According to some embodiments, business partners and data scientists work together to investigate issues and, after investigation, a project may be initiated to adjust a model. In particular, performance monitoring may be performed at 302 to proactively identify potential issues. At 304, the system may provide an ability to re-train a model quickly and implement relevant factors. At 306, self service tools may unlock additional analysis for the business and a capacity to explore unconstrained modeling may be created at 308.

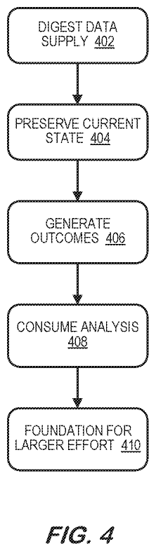

Some embodiments may be associated with a model factory that streamlines maintenance activities of pricing models and supports unconstrained modeling with baseline data and model foundation. For example, FIG. 4 is a modeling process ecosystem in accordance with some embodiments. The system may digest a data supply at 402 (e.g., analytic base data may be collected at a lowest grain with standard data diagnostic and source checks provided by a performance monitoring team. The system may then preserve a current state at 404 (e.g. to remediate, monitor, and/or re-train models on a regular cadence to provide consistency and knowledge across different enterprise lines of business). The system may generate outcomes at 406 via guided tutorials of an application with standard Key Performance Indicators (“KPIs”). At 408, the system may consume the analysis (note that a value-add analysis may still be required to digest the reports generated and signals detected). Finally, some embodiments may provide a foundation for a larger effort 410 (e.g., process, tools and pricing model datasets may bring efficiency and transparency). Note that embodiments may gain speed with respect to refresh and rebuild and/or release capacity for unconstrained modeling activity.

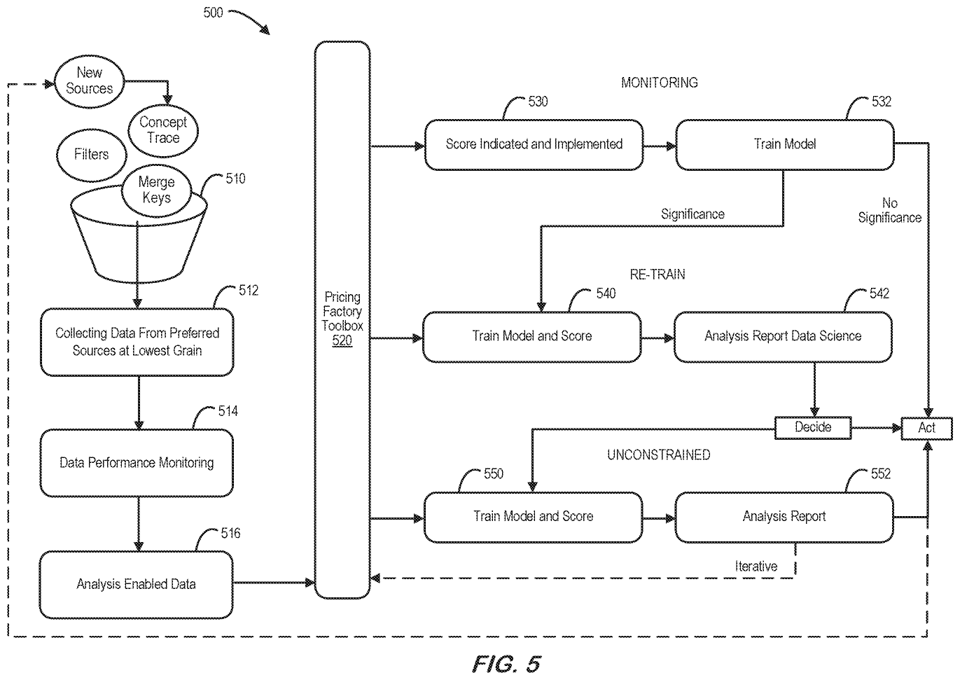

FIG. 5 is a modeling system schema 500 according to some embodiments. A data transformation portion (e.g., data, business insights, etc.) may take new sources, concept traces, filters, and merge keys to be combined 510 thus collecting data 512 from preferred sources at the lowest possible granularity. Data performance monitoring 514 may be performed along with an analysis of enabled data 516. A modeling portion of the schema 500 may include a pricing factor toolbox 520 that provides information to an output portion. The output portion might include, for example, scoring indicated and implemented information 530 during a modeling process that also trains a model 532. If something significant is found, the system may train (or re-train) and score the model 540 creating an analysis report for data science 542. The analysis report for data science 542 might result in an action or unconstrained model training and scoring 550, including rebuild and/or refresh requirements (and another analysis report 552). This process may be repeated in an iterative fashion (as illustrated by the dashed arrows in FIG. 5) to improve the model as appropriate.

According to some embodiments, the system may automatically update documentation, pull and cleanse data, identify and cleanse code, update models, and update modeling reports (e.g., in a single day). Moreover, a driver table—such as an EXCEL® workbook—may serve as documentation for models, help steer the process, and host, for example, code chunks, model structure, data items needed, data transformations, what to store, etc. Moreover, embodiments may automatically assess the impact of various new data indicators and the predictability of new data sources to a current pricing model.

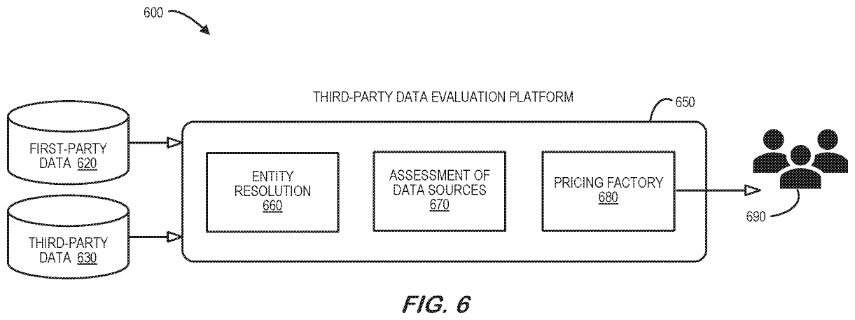

FIG. 6 illustrates data science assets 600 in accordance with some embodiments. Note that a supply (including internal first party data 620 and third-party data 630) may get processed through a third-party data evaluation platform 650. The platform 650 may, for example, evaluate the value of a new third-party data 630 source by performing an unconstrained modeling exercise and by comparing information to a pricing factory baseline model. Initially, an entity resolution 660 may strengthen an enterprise connection with the third-party data 630 to find a quicker and/or more reliable match. An assessment of data sources 670 may then provide a faster assessment of new data sources (and an indication of which elements the enterprise should focus on). A pricing factory 680 may provide an automated baseline model data to enable the fast startup of the unconstrained modeling. In this way, all three pieces 660, 670, 680 may empower data scientists 690 to perform a deep analysis and improve both the quality of analysis and the turn-around time (and even providing new insights).

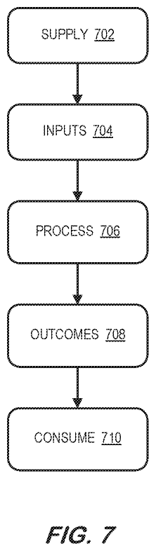

Note that according to some embodiments data is not brought in isolation to simply increase supply, but instead as an integral part of a thoughtful end to process-to-power business functions. Such an approach may help create a sustainable ecosystem to establish flexible data-driven workflows by connecting several different elements of an enterprise. FIG. 7 is a modeling system data strategy according to some embodiments. As shown, embodiments may connect supply 702 elements (e.g., internal and external data), input 704 elements (e.g., an object, people, places, events, etc.), process 706 elements, outcome 708 elements (e.g., trusted, connected, and/or curated, consume 710 elements (e.g., prospecting, underwriting, and capacity planning), etc.

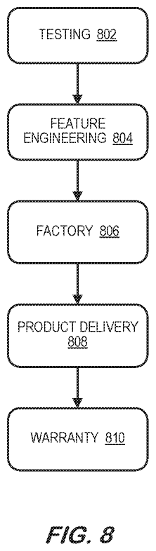

FIG. 8 is a data science modeling system workflow in accordance with some embodiments. Testing 802 may be performed by an incubation laboratory on enterprise data, third-party data, ground truth information, etc. Feature engineering 804 may be associated with a client hub, image factory, text factory, entity resolution, etc. A factory 806 may provide third-party testing, a pricing factory, location intelligence (ZIP code level data), etc. Product delivery 808 may be provided, for example, with respect to insurance claims or service. Warranty 810 may also be provided to sustain and evolve a product, model automation, performance monitoring, refresh and/or retrain models, etc.

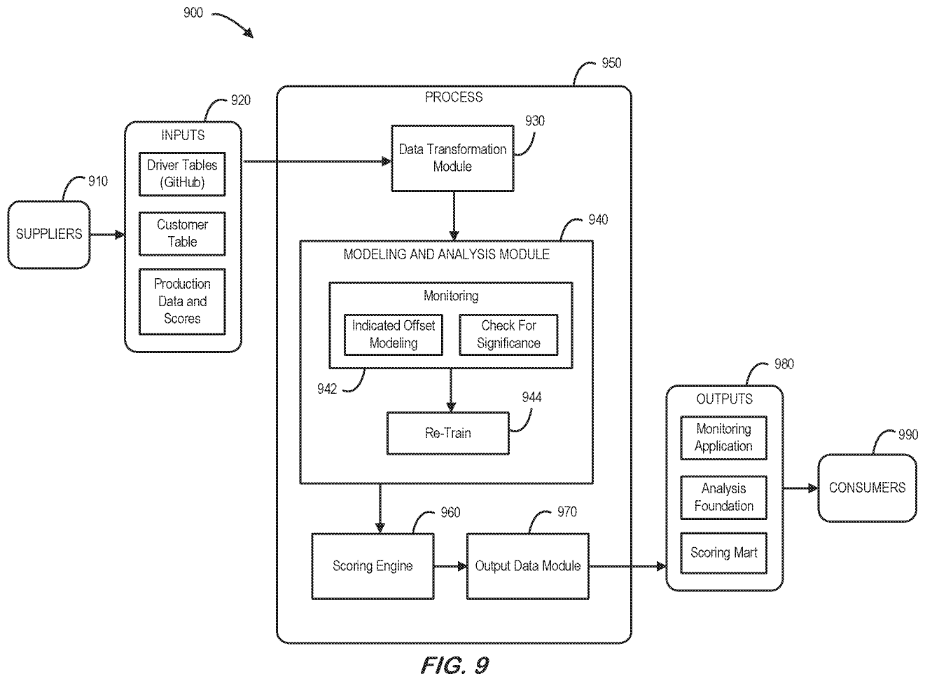

FIG. 9 is a generic model factory 900 according to some embodiments. One or more suppliers 910 (e.g., associated with Architecture Development Method (“ADM”) data, point-in-time tactical information, etc.) may provide inputs 920, such as driver tables via GitHub, a customer table, production and data scores, etc.). This information may be sent to a data transformation module 930 of a process 950 (e.g., including a read driver, an initial data pull, appropriate transformations, an analytics enabled data release, initial data testing, transformation testing, etc.). A modeling and analysis module 940 may then perform monitoring 942 (e.g., indicated offset modeling, significance checks) and re-train 944 the model as appropriate. A scoring engine 960 may score each model component and aggregate model components to create a final score that may be provided to an output data module 970 (that collects data and feeds an R-shiny application. Output 980 of the process 950, including monitoring application data (e.g., analysis reports and model documentation), analysis foundation, and a scoring mart (e.g., a risk score repository) may be provided to consumers 990 (e.g., actuarial, product, data science, underwriting, etc.).

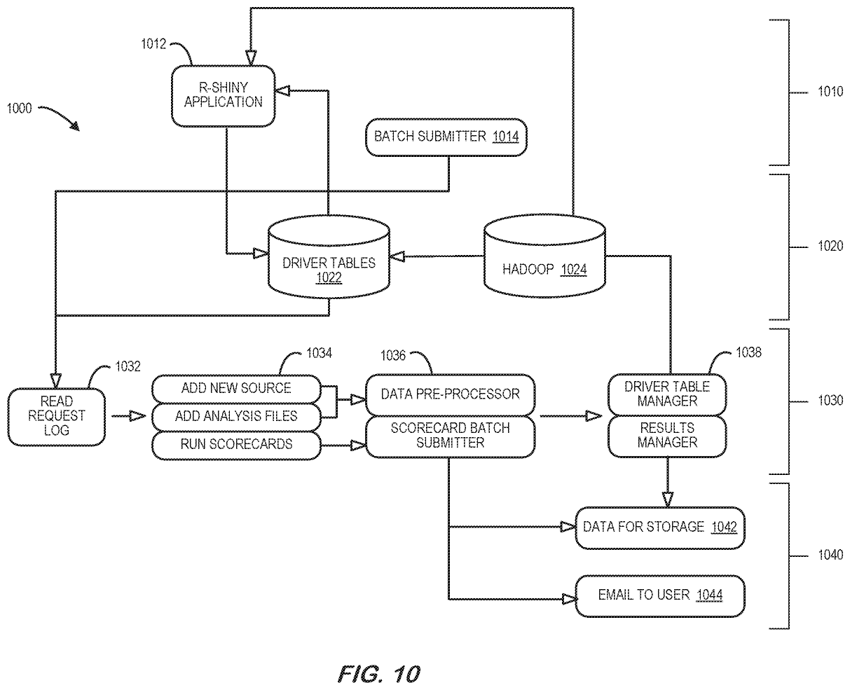

FIG. 10 is a general third-party data evaluation setup 1000 in accordance with some embodiments. A user input 1010 includes a R-shiny application 1012 may let a user upload data and initiate a process by exchanging information with driver tables 1022 in data collection. A batch submitter 1014 may provide information to a read request log 1032 in request fulfillment 1030. The setup 1000 may add new sources, add analysis files, and run scorecards 1034 and results may be provided to a data pre-processor and/or a scorecard batch submitter 1036. These elements 1036 may then provide information to a driver table manager and/or results manager 1038 that updates a Hadoop 1024 data store. In addition, data may be provided to storage 1042 and/or an email to the user 1044 in an output 1040 section of the process. According to some embodiments, an automated mining platform may access rules in an event rules database to mine received data. The mining platform may then transmit results to external systems, such as an email alert server, a workflow application, and/or reporting and calendar functions (e.g., executing on a server).

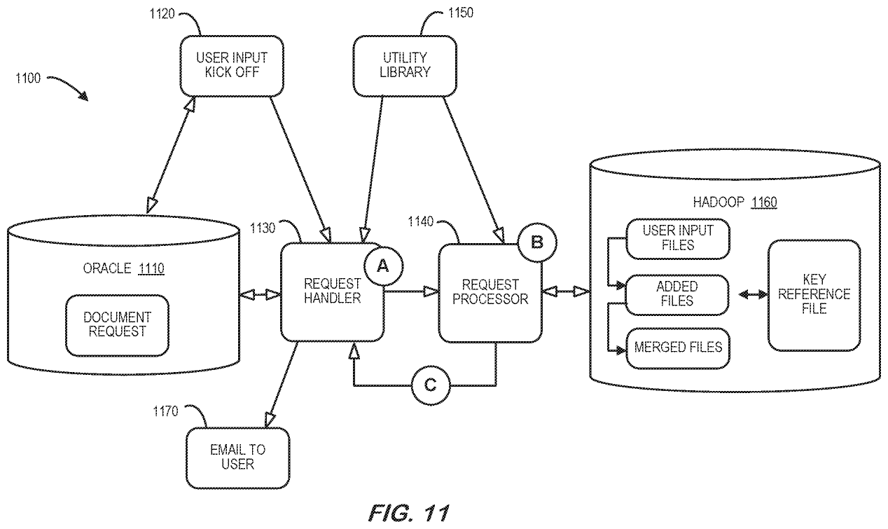

FIG. 11 illustrates third-party data evaluation orchestration 1100 according to some embodiments. An Oracle database 1110 (e.g., storing a document request) may receive information from a user input 1120 (shiny) during a kickoff. A request handler 1130 may also receive information from the user input 1120 along with a utility library 1150. A request processor 1140 may also receive information from the utility library 1150 and update a Hadoop 1160 data store (where user input files are merged with added files and key reference information is stored). The handler may also transmit an email to the user 1170. In particular, at (A) the request handler 1130 may be initiated by the user input 1120 that requests information collection and kicks off the request processor 1140. The user input 1120 may provide for user friendliness (enabling users not familiar with H2O or R to perform analysis), documentation (the application records results and reports that can be leveraged for future runs to avoid duplication), and/or allow a future addition of pricing factory models. At (B), the request processor 1140 picks up user input in Hadoop 1160 (e.g., via a Hadoop Distributed Files System (“HDFS”)), processes the request (e.g., by adding an identifier), and generate merge files based on key reference file. At (C), the orchestration 1100 performs the final steps, including returning results request handler 1130, sending out the email to the user 1170, sending a document to the Oracle database 1110, close information loop to shiny 1120, etc.

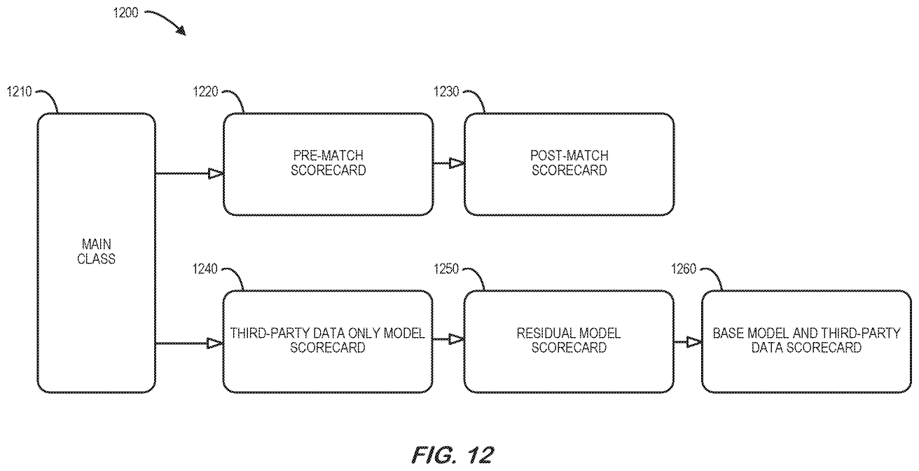

FIG. 12 illustrates third-party data scorecards 1200 in accordance with some embodiments. The scorecards 1200 may be associated with, according to some embodiments, an object-oriented design framework and include a main class 1210 (e.g., with a parameter parser, a data retriever, a metric calculation, and utility modules). A pre-match scorecard 1220 or report may comprise a pdf visual and include database of findings information (to let someone quickly go through a data set to see if it is worth processing) and a post-match scorecard 1230 may include third-party displacement information after the process merged data looking for similar things (grains, completeness, machine learning, etc.). A third-party data only model scorecard 1240 may be associated with model generation and predict a target from new data that was identified (e.g., and recommend either “yes,” “no,” or “maybe” with respect to further evaluation). A residual model scorecard 1250 may comprise a visualization while a base model and third-party data scorecard 1260 may bring information together to complete the evaluation.

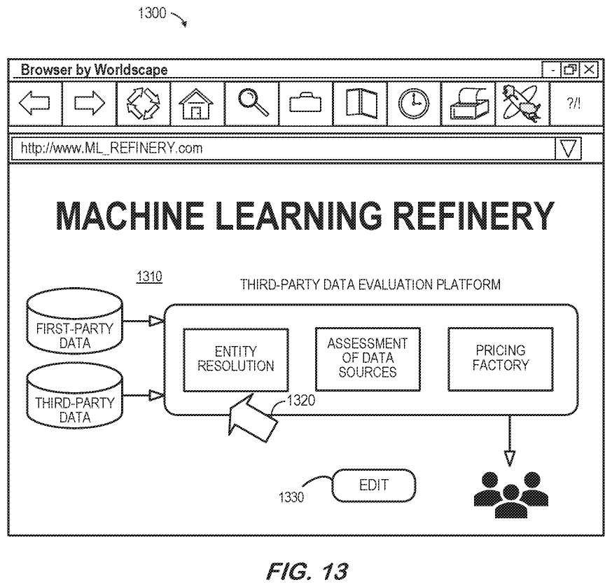

According to some embodiments, an administrator or operator interface may display various Graphical User Interface (“GUI”) elements. For example, FIG. 13 illustrates a machine learning refinery GUI display 1300 in accordance with some embodiments of the present invention. The display 1300 may include a graphical representation 1310 of the components associated with a third-party data evaluation platform. According to some embodiments, an administrator or operator may then select an element (e.g., via a touchscreen or computer mouse pointer 1320) to see more information about that element (e.g., in a popup window) and or adjust parameters (e.g., linking to a new third-party data source). Selection of an “Edit” icon 1330 may also allow for alteration of the system's operation.

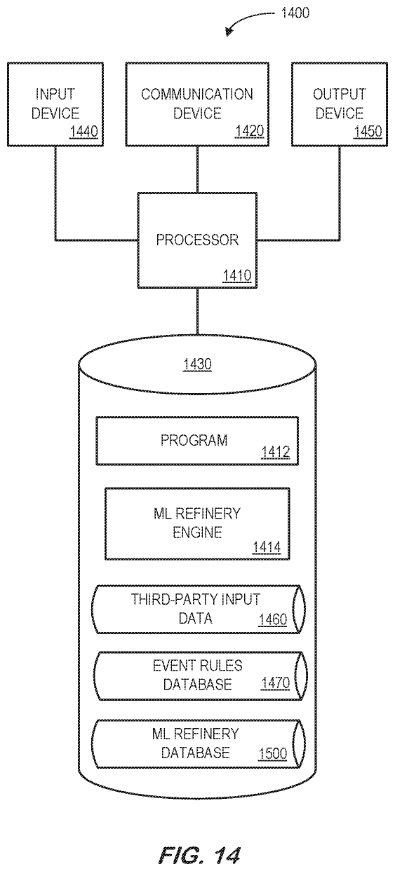

The embodiments described herein may be implemented using any number of different hardware configurations. For example, FIG. 14 illustrates a platform or apparatus 1400 that may be, for example, associated with the system 100 of FIG. 1 as well as the other systems described herein. The apparatus 1400 comprises a processor 1410, such as one or more commercially available Central Processing Units (“CPUs”) in the form of one-chip microprocessors, coupled to a communication device 1420 configured to communicate via a communication network (not shown in FIG. 14). The communication device 1420 may be used to communicate, for example, with one or more first-party and/or third-party data sources and risk applications. The apparatus 1400 further includes an input device 1440 (e.g., a mouse and/or keyboard to define data rules and events) and an output device 1450 (e.g., a computer monitor to display reports and data mining results to an administrator).

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1412 and/or a machine learning refinery engine 1414 (e.g., associated with a modeling system engine plug-in) for controlling the processor 1410. The processor 1410 performs instructions of the programs 1412, 1414, and thereby operates in accordance with any of the embodiments described herein. For example, the processor 1410 may evaluate third-party data for an enterprise, including information about potential customers via a first-party data source and additional information about the potential customers from sources other than the enterprise via a third-party data source. The processor 1410 may provide information about at least one enterprise predictive model and analyze the additional information to determine an impact on the enterprise predictive model. The processor 1410 may then output an indication of a result of said analysis to a database of findings (e.g., for use by data scientists).

The programs 1412, 1414 may be stored in a compressed, uncompiled and/or encrypted format. The programs 1412, 1414 may furthermore include other program elements, such as an operating system, a database management system, and/or device drivers used by the processor 1410 to interface with peripheral devices.

As used herein, information may be “received” by or “transmitted” to, for example: (i) the apparatus 1400 from another device; or (ii) a software application or module within the apparatus 1400 from another software application, module, or any other source.

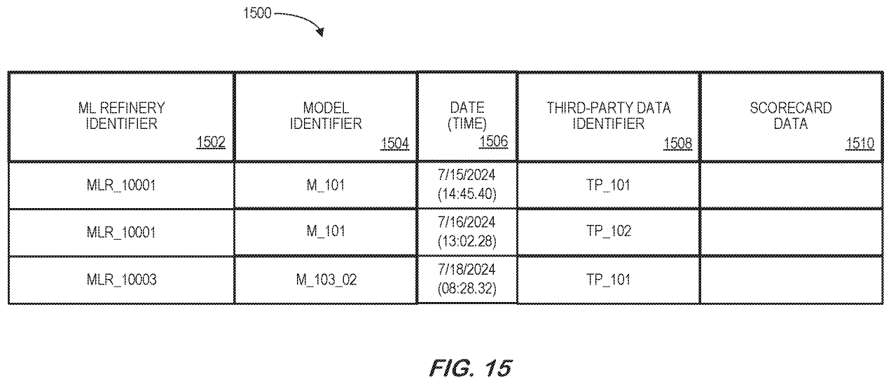

In some embodiments (such as shown in FIG. 14), the storage device 1430 further stores third-party input data 1460, an event rules database 1470, and a Machine Learning (“ML”) refinery database 1500. An example of a database that may be used in connection with the apparatus 1400 will now be described in detail with respect to FIG. 15. Note that the database described herein is only one example, and additional and/or different information may be stored therein. Moreover, various databases might be split or combined in accordance with any of the embodiments described herein.

Referring to FIG. 15, a table is shown that represents the ML refinery database 1500 that may be stored at the apparatus 1400 according to some embodiments. The table may include, for example, entries identifying rules and algorithms that may facilitate third-party data evaluation and/or mining. The table may also define fields 1502, 1504, 1506, 1508, 1510 for each of the entries. The fields 1502, 1504, 1506, 1508, 1510 may, according to some embodiments, specify: ML refinery identifier 1502, a model identifier 1504, a date and time 1506, a third-party data identifier 1508, and scorecard data 1510. The ML refinery database 1500 may be created and updated, for example, based on information received from an operator or administrator (e.g., when a potential new data source is added).

The ML refinery 1502 may be, for example, a unique alphanumeric code identifying a system currently be operated by an enterprise. The model identifier 1504 might indicate an enterprise predictive model that is be evaluated and the date and time 1506 might indicate the last time the model was updated or executed. The third-party data identifier 1508 may indicate a data source that is providing information to be evaluated and the scorecard data 1510 may include the results of that evaluation (e.g., a category or numerical score).

According to some embodiments, the third-party data evaluation is associated with a “big data” activity that may use machine learning to sift through large amounts of unstructured data to find meaningful patterns to support business decisions. As used herein, the phrase “big data” may refer to massive amounts of data that are collected over time that may be difficult to analyze and handle using common database management tools. This type of big data may include web data, business transactions, email messages, activity logs, and/or machine-generated data. In addition, data from sensors, unstructured documents posted on the Internet, such as blogs and social media, may be included in embodiments described herein.

According to some embodiments, the data evaluation performed herein may be associated with hypothesis testing. For example, one or more theories may be provided (e.g., “the elimination of this parameter will not negatively impact underwriting decisions”). Knowledge engineering may then translate common smart tags for industry and scenario specific business context analysis.

In some embodiments, the data and model evaluations described herein may be associated with insight discovery wherein unsupervised data mining techniques may be used to discover common patterns in data. For example, highly recurrent themes may be classified, and other concepts may then be highlighted based on a sense of adjacency to these recurrent themes. In some cases, cluster analysis and drilldown tools may be used to explore the business context of such themes. For example, sentiment analysis may be used to determine how an entity is currently perceived and/or the detection of a real-world event may be triggered (e.g., it might be noted that a particular automobile model is frequently experiencing a particular unintended problem).

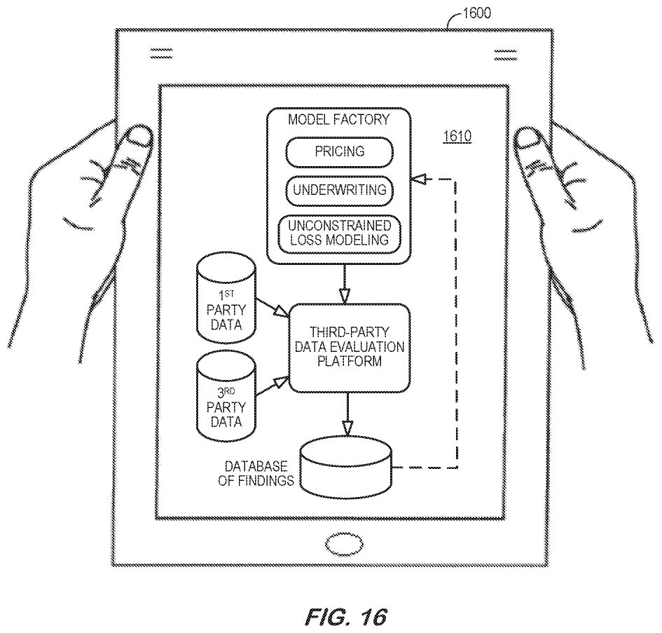

Thus, embodiments may provide improved third-party data evaluation for a modeling system. FIG. 16 illustrates a wireless or tabular device 1600 displaying elements of a system in accordance with some embodiments of the present invention. For example, in some embodiments, the device 1600 is an iPhone® from Apple, Inc., a BlackBerry® from RIM, a mobile phone using the Google Android® operating system, a portable or tablet computer (such as the iPad® from Apple, Inc.), a mobile device operating the Android® operating system or other portable computing device having an ability to communicate wirelessly with a remote entity.

The device 1600 presents a display 1610 that may be used to display information about a data evaluation system. For example, the elements may be selected by an operator (e.g., via a touchscreen interface of the device 1600) to view more information about that element and/or to adjust settings or parameters associated with that element (e.g., to introduce a new third-party data source to the system).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). Applicants have discovered that embodiments described herein may be particularly useful in connection with insurance policies and associated claims. Note that other types of business and risk data may also benefit from the present invention. For example, embodiments might be used in connection with bank loan applications, warranty services, etc.

Moreover, although some embodiments have been described with respect to particular data evaluation approaches, note that any of the embodiments might instead be associated with other information processing techniques. For example, third-party evaluations may be performed to process and/or mine certain characteristic information from various social networks to determine whether a party is engaging in certain risky behavior or providing high risk products. It is also contemplated that embodiments may process data including text in one or more languages, such English, French, Arabic, Spanish, Chinese, German, Japanese and the like. In an exemplary embodiment, a system can be employed for sophisticated data analyses, wherein information can be recognized irrespective of the source.

According to some embodiments, third-party data may be used in conjunction with one or more predictive models to take into account a large number of underwriting and/or other parameters. The predictive model(s), in various implementations, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior data and outcomes known to the risk company. The specific data and outcomes analyzed may vary depending on the desired functionality of the particular predictive model. The particular data parameters selected for analysis in the training process may be determined by using regression analysis and/or other statistical techniques known in the art for identifying relevant variables and associated weighting factors in multivariable systems. The parameters can be selected from any of the structured data parameters stored in the present system (e.g., tags and event data), whether the parameters were input into the system originally in a structured format or whether they were extracted from previously unstructured objects, such as from big data.

In the present invention, the selection of weighting factors (either on an event level or a data source level) may improve the predictive power of the data mining. For example, more reliable data sources may be associated with a higher weighting factor, while newer or less reliable sources might be associated with a relatively lower weighting factor.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to evaluate third-party data for an enterprise, comprising:
a first-party data source to provide information about potential customers from the enterprise;
a third-party data source to provide additional information about the potential customers from sources other than the enterprise;
a model factory to provide information about at least one enterprise predictive model;
a third-party data evaluation platform coupled to the first-party data source, the third-party data source, and the model factory platform, including:
a computer processor; and
a storage device in communication with said processor and storing instructions adapted to be executed by said processor to:
(i) receive information about the enterprise predictive model from the model factory,
(ii) receive the additional information about the potential customers from the third-party data source,
(iii) analyze the additional information to determine an impact on the enterprise predictive model in connection with potential risk applications for insurance company underwriting, and
(iv) output an indication of a result of said analysis; and
a database of findings to store information about the indication of the result of said analysis,
wherein the system executes performance monitoring using machine learning to automatically and proactively identify potential issues,
wherein the system automatically re-trains the enterprise predictive model using the additional information about the potential customers from the third-party data source, and
wherein information in the database of findings is used by data scientists and an unconstrained loss modeling team to identify and feedback important information to an unconstrained loss modeling component of the model factory.

2. (canceled)

3. The system of claim 1, wherein said identification is performed via cloud analytics associated with at least one of: (i) object storage, (ii) a data catalog, (iii) a data lake store, (iv) a data factory, (v) machine learning, and (vi) artificial intelligence services.

4. (canceled)

5. The system of claim 1, wherein the system automatically scores the additional information about the potential customers from the third-party data source.

6. The system of claim 1, wherein the information from the first-party or third-party data source include all of: a risk claim file, a medical report, a police report, and social network data.

7. The system of claim 1, wherein a first enterprise predictive model is associated with large loss and volatile claim detection and a second enterprise predictive model is associated with a premium evasion analysis.

8. The system of claim 7, wherein the indication of the result of said analysis is to: (i) trigger a risk application, or (ii) update a risk application.

9. The system of claim 1, wherein the indication of the result of said analysis is associated with a variable or weighing factor of a predictive model.

10. A computer-implemented method to evaluate third-party data for an enterprise, comprising:
receiving from the enterprise information about potential customers via a first-party data source;
receiving from sources other than the enterprise additional information about the potential customers via a third-party data source;
receiving information about at least one enterprise predictive model from a model factory;
analyzing, by a third-party data evaluation platform, the additional information to determine an impact on the enterprise predictive model in connection with potential risk applications for insurance company underwriting; and
storing an indication of a result of said analysis in a database of findings,
wherein a system associated with the method executes performance monitoring using machine learning to automatically and proactively identify potential issues,
wherein the system automatically re-trains the enterprise predictive model using the additional information about the potential customers from the third-party data source, and
wherein information in the database of findings is used by data scientists and an unconstrained loss modeling team to identify and feedback important information to an unconstrained loss modeling component of the model factory
executes performance monitoring to automatically and proactively identify potential issues and automatically re-trains the enterprise predictive model using the additional information about the potential customers from the third-party data source.

11. (canceled)

12. The method of claim 10, wherein said identification is performed via cloud analytics associated with at least one of: (i) object storage, (ii) a data catalog, (iii) a data lake store, (iv) a data factory, (v) machine learning, and (vi) artificial intelligence services.

13. (canceled)

14. The method of claim 10, further comprising:
automatically scoring the additional information about the potential customers from the third-party data source.

15. The method of claim 10, wherein the information from the first-party or third-party data source include all of: a risk claim file, a medical report, a police report, and social network data.

16. The method of claim 10, wherein a first enterprise predictive model is associated with large loss and volatile claim detection and a second enterprise predictive model is associated with a premium evasion analysis.

17. The method of claim 16, wherein the indication of the result of said analysis is to: (i) trigger a risk application, or (ii) update a risk application.

18. The method of claim 10, wherein the indication of the result of said analysis is associated with a variable or weighing factor of a predictive model.

19. A non-transitory, computer-readable medium storing instructions adapted to be executed by a computer processor to perform a method to evaluate third-party data for an enterprise, said method comprising:
receiving from the enterprise information about potential customers via a first-party data source;
receiving from sources other than the enterprise additional information about the potential customers via a third-party data source;
receiving information about at least one enterprise predictive model from a model factory;
analyzing, by a third-party data evaluation platform, the additional information to determine an impact on the enterprise predictive model in connection with potential risk applications for insurance company underwriting; and
storing an indication of a result of said analysis in a database of findings,
wherein a system associated with the method executes performance monitoring using machine learning to automatically and proactively identify potential issues,
wherein the system automatically re-trains the enterprise predictive model using the additional information about the potential customers from the third-party data source, and
wherein information in the database of findings is used by data scientists and an unconstrained loss modeling team to identify and feedback important information to an unconstrained loss modeling component of the model factory.

20. (canceled)

21. The medium of claim 19, wherein said identification is performed via cloud analytics associated with at least one of: (i) object storage, (ii) a data catalog, (iii) a data lake store, (iv) a data factory, (v) machine learning, and (vi) artificial intelligence services.
